(19) United States
(12) Patent Application Publication
(10) Pub. No.: US 2025/0315096 A1
(43) Pub. Date: Oct. 9, 2025

(54) POWER CONSUMPTION CONTROL METHOD AND APPARATUS FOR GRAPHICS PROCESSING UNIT, DEVICE, MEDIUM AND PROGRAM PRODUCT

(71) Applicant: Moore Threads Technology Co., Ltd., Haidian District (CN)

(72) Inventors: Qiuyang Duan, Beijing (CN); Jue Yang, Beijing (CN); Shaoyang Ma, Beijing (CN); Jianhong Luo, Beijing (CN); Shangshan Yang, Beijing (CN); Yubo Zhang, Beijing (CN)

(21) Appl. No.: 19/246,463

(22) Filed: Jun. 23, 2025

Related U.S. Application Data
(63) Continuation of application No. PCT/CN2023/139860, filed on Dec. 19, 2023.

(30) Foreign Application Priority Data
Dec. 23, 2022 (CN) 202211667305.9

(51) Int. Cl. G06F 1/3234; G06F 1/3228; G06F 1/3296

(52) U.S. Cl. CPC G06F 1/3243; G06F 1/3228; G06F 1/3296

(57) ABSTRACT

The present disclosure relates to the technical field of electronic digital data processing, in particular to a method for controlling power consumption of a graphics processing unit (GPU), an apparatus, and a program product. The method comprises: acquiring a current toggle rate of a GPU; determining a target voltage-frequency scaling relationship corresponding to the GPU currently based on the current toggle rate; and determining a target operating voltage and a target operating frequency of the GPU based on the target voltage-frequency scaling relationship.

### CROSS-REFERENCE TO RELATED APPLICATION

The present application is based upon and claims the benefit of priority of Chinese Patent Application No. 202211667305.9 filed with the CNIPA on Dec. 23, 2022 and International Application No. PCT/CN2023/139860 filed on Dec. 19, 2023, the entire contents of which are incorporated herein by reference.

### TECHNICAL FIELD

The present disclosure relates to the technical field of electronic digital data processing, in particular to a method for controlling power consumption of a graphics processing unit (hereinafter referred to as GPU), a device for controlling power consumption of a GPU, an electronic apparatus, a storage medium, and a program product.

### BACKGROUND

Currently, it is common for the operating system (OS) to maintain a voltage-frequency scaling table for the GPU. The host end, based on the current state of the host, instructs the GPU to switch its operating frequency and operating voltage to meet performance metrics.

The voltage-frequency scaling table maintained by the operating system is typically derived by the chip validation team through testing under the most adverse conditions to ensure that the GPU can function properly even in the worst-case scenarios.

However, the above approach results in a low performance-to-power ratio for the GPU.

### SUMMARY

The present disclosure provides a method for controlling power consumption of a graphics processing unit, an electronic apparatus, a storage medium, and a program product.

According to one aspect of the present disclosure, there is provided a method for controlling power consumption of a GPU, comprising:
acquiring a current toggle rate of the GPU;
determining a target voltage-frequency scaling relationship corresponding to the GPU currently based on the current toggle rate; and
determining a target operating voltage and a target operating frequency of the GPU based on the target voltage-frequency scaling relationship.

By acquiring the current toggle rate of the GPU, determining the target voltage-frequency scaling relationship corresponding to the GPU currently based on the current toggle rate, and then determining the target operating voltage and the target operating frequency of the GPU based on the target voltage-frequency scaling relationship, it is possible to determine a voltage-frequency scaling relationship suitable for a current scenario based on the current toggle rate of the GPU, so as to determine an operating voltage and an operating frequency suitable for the current scenario, thus improving the performance-to-power ratio of the GPU.

In one possible implementation, acquiring the current toggle rate of the GPU comprises:
acquiring current power consumption parameters of the GPU; and
determining the current toggle rate of the GPU based on the current power consumption parameters.

In this implementation, by acquiring the current power consumption parameters of the GPU and determining the current toggle rate of the GPU based on the current power consumption parameters, the current toggle rate of the GPU may be accurately determined.

In one possible implementation, the current power consumption parameters include at least two of the following:
a duty cycle, an operating period, a maximum power consumption, a current power consumption, a current operating frequency, and a current operating voltage.

In this implementation, by determining the current toggle rate of the GPU based on at least two of the duty cycle, the operating period, the maximum power consumption, the current power consumption, the current operating frequency, and the current operating voltage, the accuracy of the determined current toggle rate may be improved.

In one possible implementation, determining the current toggle rate of the GPU based on the current power consumption parameters comprises:
determining a ratio of the maximum power consumption to the current power consumption; and
determining the current toggle rate of the GPU based on the duty cycle, the operating period, the ratio, the current operating frequency, and the current operating voltage.

In this implementation, by determining the ratio of the maximum power consumption to the current power consumption, and determining the current toggle rate of the GPU based on the duty cycle, the operating period, the ratio, the current operating frequency, and the current operating voltage, the accurate current toggle rate may more precisely reflect the current scenario of the GPU.

In one possible implementation, determining the current toggle rate of the GPU based on the current power consumption parameters comprises:
inputting the current power consumption parameters into a pre-trained neural network, and outputting the current toggle rate through the neural network.

In this implementation, by pre-training a neural network for determining the toggle rate based on the power consumption parameters, inputting the current power consumption parameters into the pre-trained neural network, and outputting the current toggle rate through the neural network, the accuracy of the determined current toggle rate may be improved.

In one possible implementation, determining the target operating voltage and the target operating frequency of the GPU based on the target voltage-frequency scaling relationship comprises:
deriving a ratio function of the power consumption to the operating frequency of the GPU based on the target voltage-frequency scaling relationship and the current toggle rate;
differentiating the ratio function with respect to the operating voltage, and determining the target operating voltage based on an extremum point; and
determining the target operating frequency based on the target operating voltage and the target voltage-frequency scaling relationship.

In this implementation, by deriving the ratio function of the power consumption to the operating frequency of the GPU based on the target voltage-frequency scaling relationship and the current toggle rate, differentiating the ratio function with respect to the operating voltage, determining the target operating voltage based on the extremum point, and then determining the target operating frequency based on the target operating voltage and the target voltage-frequency scaling relationship, the performance-to-power ratio of the GPU may be maintained at the theoretical optimum.

According to one aspect of the present disclosure, there is provided a device for controlling power consumption a GPU, comprising:
an acquisition module configured to acquire a current toggle rate of the GPU;
a first determination module configured to determine a target voltage-frequency scaling relationship corresponding to the GPU currently based on the current toggle rate; and
a second determination module configured to determine a target operating voltage and a target operating frequency of the GPU based on the target voltage-frequency scaling relationship.

In one possible implementation, the acquisition module is configured to:
acquire current power consumption parameters of the GPU; and
determine a current toggle rate of the GPU based on the current power consumption parameters.

In one possible implementation, the current power consumption parameters include at least two of the following:
a duty cycle, an operating period, a maximum power consumption, a current power consumption, a current operating frequency, and a current operating voltage.

In one possible implementation, the acquisition module is configured to:
determine a ratio of the maximum power consumption to the current power consumption; and
determine a current toggle rate of the GPU based on the duty cycle, the operating period, the ratio, the current operating frequency, and the current operating voltage.

In one possible implementation, the acquisition module is configured to:
input the current power consumption parameters into a pre-trained neural network, and output the current toggle rate through the neural network.

In one possible implementation, the second determination module is configured to:
derive a ratio function of the power consumption to the operating frequency of the GPU based on the target voltage-frequency scaling relationship and the current toggle rate;
differentiate the ratio function with respect to the operating voltage and determine a target operating voltage based on an extremum point; and
determine a target operating frequency based on the target operating voltage and the target voltage-frequency scaling relationship.

According to one aspect of the present disclosure, there is provided an electronic apparatus, comprising: one or more processors; and a storage for storing executable instructions, wherein the one or more processors are configured to invoke the executable instructions stored in the storage to perform the methods described above.

According to one aspect of the present disclosure, there is provided a computer readable storage medium having computer program instructions stored therein, wherein the computer program instructions, when executed by a processor, implement the methods described above.

According to one aspect of the present disclosure, there is provided a computer program product comprising computer readable code, or a non-transitory computer readable storage medium carrying computer readable code, wherein when the computer readable code runs in an electronic apparatus, a processor of the electronic apparatus performs the methods described above.

According to an embodiment of the present disclosure, by acquiring the current toggle rate of the GPU, determining the target voltage-frequency scaling relationship corresponding to the GPU currently based on the current toggle rate, and then determining the target operating voltage and target operating frequency of the GPU based on the target voltage-frequency scaling relationship, it is possible to determine a voltage-frequency scaling relationship suitable for the current scenario based on the current toggle rate of the GUP, so as to determine an operating voltage and an operating frequency suitable for the current scenario, thus improving the performance-to-power ratio of the GPU.

It is appreciated that the above general descriptions and the detailed descriptions hereinafter are merely exemplary and explanatory, and are not intended to limit the present disclosure.

Other features and aspects of the present disclosure will become apparent in light of the following detailed descriptions of the exemplary embodiments with reference to the drawings.

### BRIEF DESCRIPTION OF THE DRAWINGS

The drawings, which are incorporated in and constitute a part of the description, illustrate embodiments of the present disclosure and, together with the description, serve to explain the technical solution of the present disclosure.

FIG. 1 is a flow chart of a method for controlling power consumption of a GPU provided by an embodiment of the present disclosure.

FIG. 2 is a block diagram of a device for controlling power consumption of a GPU provided by an embodiment of the present disclosure.

FIG. 3 is a block diagram of an electronic apparatus 300 provided by an embodiment of the present disclosure.

### DETAILED DESCRIPTION

Various exemplary embodiments, features and aspects of the present disclosure will be explained in detail below with reference to the drawings. In the drawings, the same reference signs denote elements with the same or similar functions. Although various aspects of the embodiments are shown in the drawings, unless otherwise specified, the drawings are not necessarily drawn to scale.

The word “exemplary” used here means “serving as an example, embodiment or illustration”. Any embodiment described here as “exemplary” is not necessarily to be interpreted as superior to or better than other embodiments.

The term “and/or” used herein is only for describing an association relationship between the associated objects, which means that there may be three relationships, for example, A and/or B may denote three situations: A exists alone, both A and B exist, and B exists alone. Furthermore, the expression “at least one” used herein implies any one of a plurality of elements or any combination of at least two of a plurality of elements. For example, including at least one of A, B, and C can imply that any one element or more than one element selected from a group consisting of A, B, and C is included.

In addition, to better explain the present disclosure, numerous details are given in the following embodiments. It is appreciated by those skilled in the art that the present disclosure can still be implemented without some specific details. In some embodiments, methods, means, elements and circuits well known to those skilled in the art are not described in detail in order to highlight the gist of the present disclosure.

An embodiment of the present disclosure provides a method for controlling power consumption of a GPU, wherein by acquiring a current toggle rate of the GPU, determining a target voltage-frequency scaling relationship corresponding to the GPU currently based on the current toggle rate, and determining a target operating voltage and a target operating frequency of the GPU based on the target voltage-frequency scaling relationship, it is possible to determine a voltage-frequency scaling relationship suitable for a current scenario based on the current toggle rate of the GPU, so as to determine an operating voltage and an operating frequency suitable for the current scenario, thus improving a performance-to-power ratio of the GPU.

The method for controlling power consumption of a GPU provided by an embodiment of the present disclosure is described in detail below with reference to the drawings.

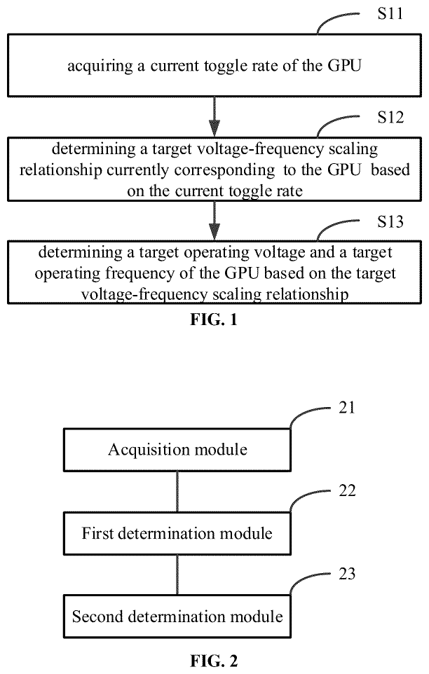

FIG. 1 is a flow chart of a method for controlling power consumption of a GPU provided by an embodiment of the present disclosure. In one possible implementation, the execution subject of the method for controlling power consumption of a GPU may be a device for controlling power consumption of a GPU. For example, the method for controlling power consumption of a GPU may be carried out by a terminal device, a server, or other electronic apparatuses. The terminal device may be a user equipment (UE), a mobile device, a user terminal, a terminal, a cellular phone, a cordless phone, a personal digital assistant (PDA), a handheld device, a computing device, a vehicular device, a wearable device, or the like. In some possible implementations, the method for controlling power consumption of a GPU may be implemented by a processor invoking computer readable instructions stored in a storage. As shown in FIG. 1, the method for controlling power consumption of the GPU comprises steps S11 to S13.

In step S11, a current toggle rate of the GPU is acquired.

In step S12, based on the current toggle rate, a target voltage-frequency scaling relationship corresponding to the GPU currently is determined.

In step S13, a target operating voltage and a target operating frequency of the GPU are determined based on the target voltage-frequency scaling relationship.

The toggle rate may represent the number of signal toggles per unit time. The current toggle rate of the GPU may indicate the toggle rate of the GPU at the current time. The current toggle rate of the GPU may be calculated based on preset parameters or extracted using preset tools, which is not limited here.

In one possible implementation, acquiring the current toggle rate of the GPU comprises: acquiring current power consumption parameters of the GPU; and determining the current toggle rate of the GPU based on the current power consumption parameters.

In this implementation, the power consumption parameters of the GPU may be any parameters capable of representing the power consumption of the GPU. Correspondingly, the current power consumption parameters of the GPU may be any parameters capable of representing the current power consumption of the GPU. In this implementation, the current toggle rate of the GPU may be determined based on at least one current power consumption parameter of the GPU. For example, the current toggle rate of the GPU may be determined based on two or more current power consumption parameters of the GPU.

In this implementation, by acquiring the current power consumption parameters of the GPU and determining the current toggle rate of the GPU based on the current power consumption parameters, the current toggle rate of the GPU may be accurately determined.

As an example of this implementation, the current power consumption parameters include at least two of the following: a duty cycle, an operating period, a maximum power consumption, a current power consumption, a current operating frequency, and a current operating voltage.

In this example, the power consumption of the GPU may be read by a preset device for detecting power consumption. For example, the preset device for detecting power consumption may be an INA3221 or the like, which is not limited here. The preset device for detecting power consumption may trigger an interrupt in response to the GPU's power consumption reaching a preset threshold for power consumption. Additionally, a system management controller (SMC) in the GPU may periodically read power consumption data of the GPU from the preset device for detecting power consumption. Compared with the approach in the related art where the operating system solely controls the power consumption of the GPU, this example involves the GPU's participation in combined control, thereby achieving power consumption optimization not only at the operating system level but also at the GPU level.

Based on the power consumption of the GPU and the number of interrupts acquired within a preset time period, the duty cycle, operating period, maximum power consumption, and current power consumption of the current scenario may be acquired. For example, the duty cycle D=t₂/(t₁+t₂), the operating period C=t₁+t₂, the maximum power consumption may be denoted by Pₘₐₓ, and the current power consumption may be denoted by P_{current}.

In this example, the current operating frequency and/or the current operating voltage may also be acquired. Here, the current operating frequency may be denoted by f_{current}, and the current operating voltage may be denoted by v_{current}.

In one example, the current power consumption parameters may include the duty cycle, operating period, maximum power consumption, current power consumption, current operating frequency, and current operating voltage.

In this example, by determining the current toggle rate of the GPU based on at least two of the duty cycle, operating period, maximum power consumption, current power consumption, current operating frequency, and current operating voltage, the accuracy of the determined current toggle rate may thus be improved.

In one example, determining the current toggle rate of the GPU based on the current power consumption parameters comprises: determining a ratio of the maximum power consumption to the current power consumption; and determining the current toggle rate of the GPU based on the duty cycle, the operating period, the ratio, the current operating frequency, and the current operating voltage.

A ratio R of the maximum power consumption to the current power consumption is given by R=Pₘₐₓ/P_{current}.

In this example, by determining the ratio of the maximum power consumption to the current power consumption, and determining the current toggle rate of the GPU based on the duty cycle, the operating period, the ratio, the current operating frequency, and the current operating voltage, the resulting accurate current toggle rate may more accurately reflect the current scenario of the GPU.

In another example, determining the current toggle rate of the GPU based on the current power consumption parameters comprises: determining a ratio of the current power consumption to the maximum power consumption; and determining the current toggle rate of the GPU based on the duty cycle, the operating period, the ratio, the current operating frequency, and the current operating voltage.

In yet another example, the current power consumption parameters further include at least one of an average power consumption, an average operating frequency, an average operating voltage, a maximum operating frequency, a minimum operating frequency, a maximum operating voltage, and a minimum operating voltage, etc., which is not limited here.

As an example of this implementation, determining the current toggle rate of the GPU based on the current power consumption parameters comprises: inputting the current power consumption parameters into a pre-trained neural network; and outputting the current toggle rate through the neural network.

In this example, by pre-training a neural network for determining the toggle rate based on the power consumption parameters, and inputting the current power consumption parameters into the pre-trained neural network and having the neural network output the current toggle rate, the accuracy of the determined current toggle rate may be improved.

As another example of this implementation method, a polynomial function may be pre-designed, and each of the current power consumption parameters may be input into the preset polynomial function to acquire the current toggle rate of the GPU.

In one possible implementation, the current toggle rate of the GPU may be acquired at a preset frequency, and the target voltage-frequency scaling relationship currently corresponding to the GPU may be re-determined in response to the current toggle rate being different from the previously acquired toggle rate.

Of course, in other implementations, the timing for acquiring the current toggle rate of the GPU may also be flexibly set based on the application scenario, which is not limited here.

In an embodiment of the present disclosure, the power consumption of the GPU may represent the total power consumption of the GPU. The total power consumption of the GPU may include the dynamic power consumption and the static power consumption of the GPU. For example, the total power consumption Pₜₒₜₐₗ of the GPU is given by Pₜₒₜₐₗ=P_{dynamic}+P_{static}, where P_{dynamic} denotes the dynamic power consumption of the GPU, and P_{static} denotes the static power consumption of the GPU. The static power consumption of the GPU may be a fixed value and may be measured using an oscilloscope or acquired through other means.

In process nodes before 40 nm, the dynamic power consumption of the GPU accounted for a large proportion of the total power consumption. However, with the evolution of process technology, the proportion of static power consumption in the total power consumption has gradually increased, reaching a level comparable to dynamic power consumption at 7 nm. This further increases the difficulty of implementing dynamic voltage and frequency scaling (DVFS).

In one example, the dynamic power consumption P_{dynamic} is given by P_{dynamic}=α×C×V²×F, where α denotes the toggle rate, C denotes a load capacitance, V denotes the operating voltage, and F denotes the operating frequency. Therefore, by reducing at least one of the toggle rate, load capacitance, operating voltage, and operating frequency, the goal of lowering power consumption can be achieved.

Since dynamic power consumption is proportional to the square of the operating voltage, a 30% reduction in the operating voltage may lead to a 50% decrease in the dynamic power consumption. Therefore, reducing voltage is a primary method for lowering the power consumption of the GPU. However, the operating voltage is constrained by factors such as the chip process technology, the switching voltage under current process conditions, and the operating frequency. The chip process technology imposes constraints on both the maximum and minimum voltages for a given process node. The switching voltage primarily limits the minimum operating voltage of the chip, and the operating frequency also restricts the minimum operating voltage of the chip.

The toggle rate may be related to factors such as the application, architecture, and design implementation, among which the toggle rate has a closer relation with the application. Specifically, the application may determine the lower limit of the toggle rate, while the architecture and the design implementation may determine the upper limit of the toggle rate. Additionally, at the implementation level, the reduction of the toggle rate may be achieved through the implementation of clock gating. In some examples, the toggle rate may also be referred to as the power factor or switching coefficient, which is not limited here.

The operating frequency of a GPU is positively correlated with its operating voltage, power consumption, and performance. Typically, we aim to maximize performance while minimizing power consumption.

The load capacitance is primarily determined by the chip process technology, and during the chip design phase, there is usually no consideration of how to proactively reduce the load capacitance.

In an embodiment of the present disclosure, at least two voltage-frequency scaling relationships may be preset. Additionally, a correspondence between the at least two voltage-frequency scaling relationships and predefined toggle rate intervals may also be preset. For example, multiple voltage-frequency scaling relationships may be preset. In any voltage-frequency scaling relationship, the operating voltage corresponding to any operating frequency may be the minimum operating voltage that can meet the operating frequency. In any voltage-frequency scaling relationship, the operating frequency corresponding to any operating voltage may be the maximum operating frequency supported by the operating voltage.

After the current toggle rate of the GPU is determined, a predefined toggle rate interval to which the current toggle rate belongs may be determined based on the magnitude of the current toggle rate, and a voltage-frequency scaling relationship corresponding to the predefined toggle rate interval to which the current toggle rate belongs may be determined as the target voltage-frequency scaling relationship.

In one possible implementation, determining the target operating voltage and target operating frequency of the GPU based on the target voltage-frequency scaling relationship comprises: deriving a ratio function of the power consumption to the operating frequency of the GPU based on the target voltage-frequency scaling relationship and the current toggle rate; differentiating the ratio function with respect to the operating voltage, and determining the target operating voltage based on an extremum point; and determining the target operating frequency based on the target operating voltage and the target voltage-frequency scaling relationship. In this implementation, the power consumption of the GPU may refer to the total power consumption of the GPU.

For example, the target voltage-frequency scaling relationship may be represented as F=f(p, V,t), where f(p, V,t)=c₀×p²+c₁×V²+c₂×t²+c₃×p×V+c₄×V×t+c₅×p×t+c₆×p+c₇×V+c₈×t, F denotes the operating frequency, V denotes the operating voltage, p denotes a process corner, t denotes the temperature, and c₀ to c₈ denote fitting parameters.

For example, the ratio function of the power consumption to the operating frequency of the GPU is given by Pₜₒₜₐₗ/F=α×C×V²+P_{static}/F, where Pₜₒₜₐₗ/F denotes power consumption required per unit frequency. By differentiating the ratio function with respect to V, the target operating voltage may be determined. Based on F=f(p, V,t), the target operating frequency may be determined.

In this implementation, first derive the ratio function of the power consumption to the operating frequency of the GPU based on the target voltage-frequency scaling relationship and the current toggle rate. Then differentiate the ratio function with respect to the operating voltage, and by determining the target operating voltage based on the extremum point, and determining the target operating frequency based on the target operating voltage and the target voltage-frequency scaling relationship, the performance-to-power ratio of the GPU may be maintained at the theoretical optimum.

In another possible implementation, the target operating frequency may first be determined based on the target voltage-frequency scaling relationship and the current toggle rate, and then the target operating voltage may be determined based on the target operating frequency and the target voltage-frequency scaling relationship.

The method for controlling power consumption of a GPU provided by the embodiment of the present disclosure will now be illustrated through a specific application scenario.

In this application scenario, the power consumption of the GPU may be read using an INA3221. The INA3221 may trigger an interrupt in response to the power consumption of the GPU reaching a preset threshold for power consumption. A system management controller (SMC) in the GPU may periodically read power consumption data of the GPU from the INA3221. Based on the power consumption of the GPU and the number of interrupts acquired within a preset time period, the duty cycle D=t₂/(t₁+t₂), the operating period C=t₁+t₂, the maximum power consumption Pₘₐₓ, and the current power consumption P_{current} of the current scenario may be acquired. Furthermore, the current operating frequency f_{current} and the current operating voltage v_{current} may be acquired. It is possible to determine a ratio R of the maximum power consumption to the current power consumption, expressed as R=Pₘₐₓ/P_{current}. The duty cycle D, the operating period C, the ratio R of the maximum power consumption to the current power consumption, the current operating frequency f_{current}, and the current operating voltage v_{current} may be input into a pre-trained neural network, and the current toggle rate of the GPU is output through the neural network.

After the current toggle rate of the GPU is determined, a predefined toggle rate interval to which the current toggle rate belongs may be determined, and the voltage-frequency scaling relationship corresponding to the predefined toggle rate interval to which the current toggle rate belongs may be determined as the target voltage-frequency scaling relationship. For example, the target voltage-frequency scaling relationship may be expressed as F=f(p, V,t), where

$$f ( p , V , t ) = {c}_{0} \times {p}^{2} + {c}_{1} \times {V}^{2} + {c}_{2} \times {t}^{2} + {c}_{3} \times p \times V + {c}_{4} \times V \times t + {c}_{5} \times p \times t + {c}_{6} \times p + {c}_{7} \times V + {c}_{8} \times t .$$

For example, the total power consumption Pₜₒₜₐₗ of the GPU is given by Pₜₒₜₐₗ=P_{dynamic}+P_{static}. Then, the ratio function Pₜₒₜₐₗ/F of the total power consumption to the operating frequency of the GPU may be expressed as Pₜₒₜₐₗ/F=α×C×V²+P_{static}/F. Differentiating the ratio function with respect to V allows for the determination of the target operating voltage. Based on F=f(p, V,t), the target operating frequency may be determined.

It is appreciated that the above method embodiments can be combined with each other to form combined embodiments, without violating the logical principles. Due to space limitations, the present disclosure will not elaborate further on these combinations. Those skilled in the art will appreciate that, in the specific implementation of the above methods, the actual execution order of the steps should be determined based on their functions and potential internal logic.

In addition, the present disclosure further provides a device for controlling power consumption of a GPU, an electronic apparatus, a computer readable storage medium, and a computer program product. All of the above may be employed to implement any of the methods for controlling power consumption of GPUs provided in the present disclosure. The corresponding technical solutions and technical effects can be found in the relevant descriptions in the method section, and thus will not be repeated here.

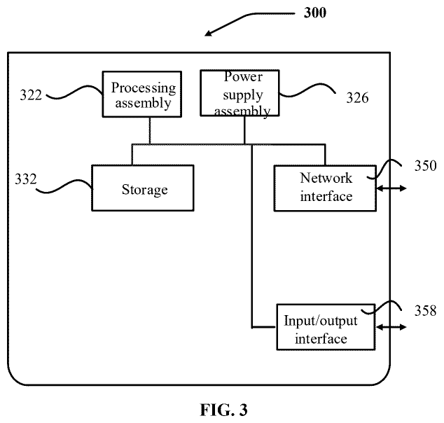

FIG. 2 is a block diagram of a device for controlling power consumption of a GPU provided by an embodiment of the present disclosure. As shown in FIG. 2, the device for controlling power consumption of the GPU comprises the following modules.

According to one aspect of the present disclosure, there is provided a device controlling power consumption of a GPU, comprising:
an acquisition module 21 configured to acquire a current toggle rate of the GPU;
a first determination module 22 configured to determine a target voltage-frequency scaling relationship corresponding to the GPU currently based on the current toggle rate; and
a second determination module 23 configured to determine a target operating voltage and a target operating frequency of the GPU based on the target voltage-frequency scaling relationship.

In one possible implementation, the acquisition module 21 is configured to:
acquire current power consumption parameters of the GPU; and
determine a current toggle rate of the GPU based on the current power consumption parameters.

In one possible implementation, the current power consumption parameters include at least two of the following:
a duty cycle, an operating period, a maximum power consumption, a current power consumption, a current operating frequency, and a current operating voltage.

In one possible implementation, the acquisition module 21 is configured to:
determine a ratio of the maximum power consumption to the current power consumption; and
determine a current toggle rate of the GPU based on the duty cycle, the operating period, the ratio, the current operating frequency, and the current operating voltage.

In one possible implementation, the acquisition module 21 is configured to:
input the current power consumption parameters into a pre-trained neural network, and output the current toggle rate through the neural network.

In one possible implementation, the second determination module 23 is configured to:
derive a ratio function of the power consumption to the operating frequency of the GPU based on the target voltage-frequency scaling relationship and the current toggle rate;
differentiate the ratio function with respect to the operating voltage and determine a target operating voltage based on an extremum point; and
determine a target operating frequency based on the target operating voltage and the target voltage-frequency scaling relationship.

In the embodiment of the present disclosure, by acquiring the current toggle rate of the GPU, determining the target voltage-frequency scaling relationship corresponding to the GPU currently based on the current toggle rate. Then determining the target operating voltage and the target operating frequency of the GPU based on the target voltage-frequency scaling relationship. Thereby it is possible to determine a voltage-frequency scaling relationship suitable for the current scenario based on the current toggle rate of the GPU, so as to determine an operating voltage and an operating frequency suitable for the current scenario. Thus improving the performance-to-power ratio of the GPU.

In some embodiments, the functions of or the modules included in the devices provided by the embodiments of the present disclosure may be used to carry out the methods described in the above method embodiments, the specific implementation and the technical effects of which may refer to the description of the above method embodiments and will not be repeated herein for the sake of brevity.

An embodiment of the present disclosure further provides a computer readable storage medium having computer program instructions stored therein, wherein the computer program instructions, when executed by a processor, implement the methods described above. The computer readable storage medium may be a non-transitory computer readable storage medium, or a transitory computer readable storage medium.

An embodiment of the present disclosure further provides a computer program comprising computer readable code, wherein when the computer readable code runs in an electronic apparatus, a processor of the electronic apparatus carries out the methods described above.

An embodiment of the present disclosure further provides a computer program product comprising computer readable code, or a non-transitory computer readable storage medium carrying computer readable code, wherein when the computer readable code runs in an electronic apparatus, a processor of the electronic apparatus carries out the methods described above.

An embodiment of the present disclosure further provides an electronic apparatus, comprising: one or more processors and a storage for storing executable instructions. The one or more processors are configured to invoke the executable instructions stored in the storage to perform the methods described above.

The electronic apparatus may be provided as a terminal, a server, or other forms of apparatuses.

FIG. 3 is a block diagram of an electronic apparatus 300 provided by an embodiment of the present disclosure.

For example, the electronic apparatus 300 may be provided as a terminal, a server, or the like. Referring to FIG. 3, the electronic apparatus 300 comprises a processing assembly 322, which further comprises one or more processors, and storage resources represented by a storage 332 for storing instructions executable by the processing assembly 322, such as application programs. The application programs stored in the storage 332 may include one or more modules, each corresponding to a set of instructions. In addition, the processing assembly 322 is configured to execute the instructions to carry out the above methods.

The electronic apparatus 300 may further comprise a power supply assembly 326 configured to perform power management of the electronic apparatus 300, a wired or wireless network interface 350 configured to connect the electronic apparatus 300 to a network, and an input/output (I/O) interface 358. The electronic apparatus 300 may operate based on an operating system stored in the storage 332, such as Windows Server™ of Microsoft, Mac OS X™ (a graphical user interface-based operating system launched by Apple), Unix™ (a multi-user and multi-process computer operating system), Linux™ (a free and open-source Unix-like operating system), and FreeBSD™ (an open-source Unix-like operating system).

An exemplary embodiment further provides a non-transitory computer readable storage medium, such as the storage 332 that includes computer program instructions. The computer program instructions may be executed by the processing assembly 322 of the electronic apparatus 300 to implement the above methods.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner. Thus, the computer readable storage medium may have instructions stored therein comprises a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable data processing devices or other devices, so as to produce a computer implemented process, such that the instructions executed on the computer, other programmable data processing devices or other devices implement the functions/acts specified in one or more blocks in the flowchart and/or block diagram.

The flowcharts and block diagrams in the drawings illustrate the architecture, function, and operation of possible implementations of the system, method, and computer program product according to the various embodiments of the present disclosure. In this regard, each block in the flowchart or block diagram may represent a part of a module, a program segment, or an instruction, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

The computer program product may be implemented specifically through hardware, software, or a combination thereof. In one optional embodiment, the computer program product is specifically embodied as a computer storage medium. In another optional embodiment, the computer program product is specifically embodied as a software product, such as a software development kit (SDK).

The above description of each embodiment tends to emphasize the differences between the embodiments. The similarities or common aspects can be used for mutual reference. For the sake of brevity, they will not be repeated here.

If the technical solutions of the embodiments of the present disclosure involve personal information, products applying the technical solutions of the embodiments of the present disclosure have clearly informed the rules for processing personal information and obtained the individual's voluntary consent before processing the personal information. If the technical solutions of the embodiments of the present disclosure involve sensitive personal information, products applying the technical solutions of the embodiments of the present disclosure have obtained the individual's separate consent and simultaneously met the requirement of “explicit consent” before processing the sensitive personal information. For example, at a personal information acquisition device such as a camera, a clear and conspicuous sign is provided to inform an individual that he or she has entered the personal information acquisition region and his or her personal information would be collected. If an individual voluntarily enters the personal information acquisition region, it is regarded as consent to the acquisition of his or her personal information. Alternatively, for a personal information processing device, when the personal information processing rules are informed by means of an obvious sign/message, personal authorization is obtained through pop-up messages or by asking the individual to upload his or her personal information by himself or herself. The personal information processing rules may include information such as the entity which processes personal information, the purpose of personal information processing, the processing method, and the types of personal information to be processed.

Although the embodiments of the present disclosure have been described above, it will be appreciated that the above descriptions are merely exemplary, but not exhaustive; and that the disclosed embodiments are not limiting. A number of variations and modifications may occur apparently to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A method for controlling power consumption of a GPU, comprising:
acquiring a current toggle rate of the GPU;
determining a target voltage-frequency scaling relationship currently corresponding to the GPU based on the current toggle rate; and
determining a target operating voltage and a target operating frequency of the GPU based on the target voltage-frequency scaling relationship.

2. The method according to claim 1, wherein acquiring the current toggle rate of the GPU comprises:
acquiring at least one current power consumption parameter of the GPU; and
determining the current toggle rate of the GPU based on the current power consumption parameter.

3. The method according to claim 2, wherein the at least one current power consumption parameter comprises at least two of the following:
a duty cycle, an operating period, a maximum power consumption, a current power consumption, a current operating frequency, and a current operating voltage.

4. The method according to claim 3, wherein determining the current toggle rate of the GPU based on the current power consumption parameter comprises:
determining a ratio of the maximum power consumption to the current power consumption; and
determining the current toggle rate of the GPU based on the duty cycle, the operating period, the ratio, the current operating frequency, and the current operating voltage.

5. The method according to claim 2, wherein determining the current toggle rate of the GPU based on the current power consumption parameter comprises:
inputting the current power consumption parameter into a pre-trained neural network, and outputting the current toggle rate through the neural network.

6. The method according to claim 1, wherein determining the target operating voltage and the target operating frequency of the GPU based on the target voltage-frequency scaling relationship comprises:
deriving a ratio function of a power consumption to an operating frequency of the GPU based on the target voltage-frequency scaling relationship and the current toggle rate;
differentiating the ratio function with respect to an operating voltage, and determining the target operating voltage based on an extremum point; and
determining the target operating frequency based on the target operating voltage and the target voltage-frequency scaling relationship.

7. An electronic apparatus, comprising:
one or more processors; and
a storage for storing executable instructions,
wherein the one or more processors are configured to invoke the executable instructions stored in the storage to perform a method for controlling power consumption of a GPU, the method comprising: acquiring a current toggle rate of the GPU; determining a target voltage-frequency scaling relationship currently corresponding to the GPU based on the current toggle rate; and determining a target operating voltage and a target operating frequency of the GPU based on the target voltage-frequency scaling relationship.

8. The electronic apparatus according to claim 7, wherein acquiring the current toggle rate of the GPU comprises:
acquiring at least one current power consumption parameter of the GPU; and
determining the current toggle rate of the GPU based on the current power consumption parameter.

9. The electronic apparatus according to claim 8, wherein the at least one current power consumption parameter comprises at least two of the following:
a duty cycle, an operating period, a maximum power consumption, a current power consumption, a current operating frequency, and a current operating voltage.

10. The electronic apparatus according to claim 9, wherein determining the current toggle rate of the GPU based on the current power consumption parameter comprises:
determining a ratio of the maximum power consumption to the current power consumption; and
determining the current toggle rate of the GPU based on the duty cycle, the operating period, the ratio, the current operating frequency, and the current operating voltage.

11. The electronic apparatus according to claim 8, wherein determining the current toggle rate of the GPU based on the current power consumption parameter comprises:
inputting the current power consumption parameter into a pre-trained neural network, and outputting the current toggle rate through the neural network.

12. The electronic apparatus according to claim 7, wherein determining the target operating voltage and the target operating frequency of the GPU based on the target voltage-frequency scaling relationship comprises:
deriving a ratio function of a power consumption to an operating frequency of the GPU based on the target voltage-frequency scaling relationship and the current toggle rate;
differentiating the ratio function with respect to an operating voltage, and determining the target operating voltage based on an extremum point; and
determining the target operating frequency based on the target operating voltage and the target voltage-frequency scaling relationship.

13. A computer program product comprising computer readable code, or a non-transitory computer readable storage medium carrying computer readable code, wherein when the computer readable code runs in an electronic apparatus, a processor of the electronic apparatus performs a method for controlling power consumption of a GPU, the method comprising: acquiring a current toggle rate of the GPU; determining a target voltage-frequency scaling relationship currently corresponding to the GPU based on the current toggle rate; and determining a target operating voltage and a target operating frequency of the GPU based on the target voltage-frequency scaling relationship.

14. The computer program product according to claim 13, wherein acquiring the current toggle rate of the GPU comprises:
acquiring at least one current power consumption parameter of the GPU; and
determining the current toggle rate of the GPU based on the current power consumption parameter.

15. The computer program product according to claim 14, wherein the at least one current power consumption parameter comprises at least two of the following:
a duty cycle, an operating period, a maximum power consumption, a current power consumption, a current operating frequency, and a current operating voltage.

16. The computer program product according to claim 15, wherein determining the current toggle rate of the GPU based on the current power consumption parameter comprises:
determining a ratio of the maximum power consumption to the current power consumption; and
determining the current toggle rate of the GPU based on the duty cycle, the operating period, the ratio, the current operating frequency, and the current operating voltage.

17. The computer program product according to claim 14, wherein determining the current toggle rate of the GPU based on the current power consumption parameter comprises:
inputting the current power consumption parameter into a pre-trained neural network, and outputting the current toggle rate through the neural network.

18. The computer program product according to claim 13, wherein determining the target operating voltage and the target operating frequency of the GPU based on the target voltage-frequency scaling relationship comprises:
deriving a ratio function of a power consumption to an operating frequency of the GPU based on the target voltage-frequency scaling relationship and the current toggle rate;
differentiating the ratio function with respect to an operating voltage, and determining the target operating voltage based on an extremum point; and
determining the target operating frequency based on the target operating voltage and the target voltage-frequency scaling relationship.
